(19) United States
(12) Patent Application Publication
(10) Pub. No.: US 2009/0002136 A1
(43) Pub. Date: Jan. 1, 2009

(54) Method of Communication Utilizing Power Line

(76) Inventor: Makoto Taguchi, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 11/579,384

(22) PCT Filed: May 7, 2004
(86) PCT No.: PCT/JP2004/006032

§ 371 Date: Aug. 25, 2008

(51) Int. Cl. G05B 11/01

(52) U.S. Cl. 340/310.11

(57) ABSTRACT

A method for performing communication by utilizing the AC current in a power line without requiring any modulation or superposition of a high frequency. In the communication method utilizing the AC current in a secondary power line (L), an electric load (e.g. a load current) is imparted to the secondary power line (L), the load current is added to one AC current wavelength of the secondary power line (L), and an AC current including the processed waveform is transmitted as an information signal.

### TECHNICAL FIELD

The present invention relates to a method of communication utilizing a power line, or more particularly, to a method of communication utilizing a power line which permits a communication to be implemented by directly utilizing alternating current on a power line without applying a high frequency signal to the power line.

### BACKGROUND ART

Recently attention is attracted to a method of communication utilizing a power line because the utilization of a power line permits a communication to be implemented by merely inserting a power supply plug into a convenience outlet while avoiding the need for a wiring work inasmuch as the power line extends everywhere across the country. A method of communication of the kind described is known in the art as a power line carrier system, for example, where a high frequency is applied to the power line as information signal. The power line carrier system is known as a network system such as echo-net, for example, or the like, and is characterized by the use of a modulation scheme as typified by the direct spectrum diffusion scheme. However, since the power line is formed by bare metal wires, which tend to act as an antenna, the application of a high frequency current as information signal to the power line causes a radio wave to be radiated from the power line, leading to an interference with radio waves. For this reason, frequencies which can be used in the method of communication of the kind described are currently limited to a frequency band of 10 kHz˜450 kHz which is unlikely to cause an interference with radio waves. On the other hand, the use of a short wave band equal to or greater than 2 MHz is also contemplated in order to secure the broadband for the carrier which is intended for carrier data, but the status of the art is reluctant to such use in view of issues of generation of various noises in such a short wave band.

Other methods of communication in which wires are used in the communication include a method of communication similar to the Morse code as used in the control of electric cars and a method of communication such as Echelons' LonWorks which is used in the control of buildings. However, these methods of communication require devoted communication channels, and exclude the direct use of the power line.

Accordingly, the present status of the art for the method of communication utilizing the power line which permits the direct use of the power line without requiring a specialized wiring work is in the process of examining a variety of techniques centered about the power line carrier system which uses the direct spectrum diffusion modulation scheme.

### DISCLOSURE OF THE INVENTION

### Issues to be Solved by the Invention

However, conventional methods of communication utilizing a power line are subject to technically and legally major problems such as a radio wave leak attributed to the high frequency band which occurs as a result of modulating and applying an information signal in the high frequency band to the power line as mentioned above and which is inevitable in order to realize the method of communication utilizing the power line of the kind described, and are also subject to problems of being susceptible to the influence of noises from home appliances where home networking is intended to be promoted.

The present invention intends to overcome above problems, and has for its object providing a method of communication utilizing a power line (hereafter simply referred to as “method of communication”) which permits a communication to be implemented by directly utilizing an alternating current on the power line without the superposition of a high frequency and without any kind of modulation.

### Means to Solve Issues

A method of communication utilizing a power line as defined in claim 1 of the present invention represents a method of communication using an alternating current on a power line and which is characterized by partially processing the waveform of the alternating current on the power line and transmitting the alternating current including the processed waveform as an information signal.

A method of communication utilizing a power line as defined in claim 2 of the present invention represents a method of communication using an alternating current on a power line and which is characterized by applying a load to the power line to process partially the waveform of the alternating current on the power line and transmitting the alternating current including the processed waveform as an information signal.

A method of communication utilizing a power line as defined in claim 3 of the present invention is characterized by applying the load from a first instrument in the invention defined in claim 2.

A method of communication utilizing a power line as defined in claim 4 of the present invention is characterized in that an upper limit is set on the load in the invention defined in claim 2 or 3.

A method of communication utilizing a power line as defined in claim 5 of the present invention is characterized by setting the magnitude of the load over a plurality of stages and imparting inherent information in accordance with the level of each load in the invention defined in claim 2 or 3.

A method of communication utilizing a power line as defined in claim 6 of the present invention represents a method of communication using an alternating current on a power line and which is characterized by partially marking the waveform of an alternating current on the power line to form a processed waveform and transmitting the alternating current including the processed waveform as an information signal.

A method of communication utilizing a power line as defined in claim 7 of the present invention is characterized in that a noise is applied as a mark in the invention defined in claim 6.

A method of communication utilizing a power line as defined in claim 8 of the present invention is characterized in that the marking comprises momentarily interrupting the waveform of the alternating current at least once in the invention defined in claim 6.

A method of communication utilizing a power line as defined in claim 9 of the present invention is characterized in that the processed waveform is processed on the basis of a command signal from a second instrument in the invention defined in one of claims 6˜8.

A method of communication utilizing a power line as defined in claim 10 of the present invention is characterized in that a plurality of processed waveforms are formed within a unit time and inherent information is imparted in accordance with the number of the processed waveforms in the invention defined in one of claims 1, 2, 3, and 7˜9.

A method of communication utilizing a power line as defined in claim 11 of the present invention is characterized in that the processed waveform is formed as referenced to the zero crossover of the waveform of the alternating current in the invention defined in one of claims 1˜10.

A method of communication utilizing a power line as defined in claim 12 of the present invention is characterized in that there are a plurality of first instruments, which are sequentially operated with a given time difference between them on the basis of a signal from the second instrument in the invention as defined in one of claims 2˜11.

A method of communication utilizing a power line as defined in claim 13 of the present invention is characterized in that the first instrument transmits a signal to the first instrument on the basis of a signal from the second instrument in the invention defined in claim 11.

### EFFECTS OF THE INVENTION

According to the invention defined in claims 1˜13 of the present invention, there can be provided a method of communication utilizing a power line which permits a communication to be implemented utilizing an alternating current on a power line without the superposition of a high frequency and without any kind of modulation.

### BEST MODES FOR TO CARRY OUT THE INVENTION

The present invention will now be described with reference to embodiments shown in FIGS. 1˜11. In the drawings, FIG. 1 is a block diagram of an exemplary communication system used in the method of communication according to the invention, FIGS. 2 (a), (b) are diagrams illustrating the principle of the method of communication according to the present invention where (a) shows a waveform diagram showing the waveform of an alternating current from a commercial power supply and (b) shows a waveform diagram indicating a processed waveform after a load signal has been applied to the waveform of the alternating current shown in (a), FIGS. 3 (a), (b) illustrate the principle of the method of communication of the present invention where (a) shows a waveform diagram when the waveform of the alternating current from the commercial power source is cut at the zero crossover and (b) shows a waveform diagram of a processed waveform including a plurality of cut waveforms, FIGS. 4˜8 are waveform diagrams showing processed waveforms in embodiments of the method of communication of the invention, FIG. 9 shows slave units of a communication system used in an embodiment of the method of communication of the invention where (a) is a block diagram showing the arrangement of slave units, (b) is a timing chart indicating the timings where the slave units are operated, and (c) shows a time axis indicating operation times of the slave units, FIG. 10 shows slave units of a communication system used in an embodiment of the method of communication of the invention where (a) is a block diagram showing the arrangement of a plurality of slave units, (b) is a timing chart showing the operation of the slave units, and FIG. 11 is a block diagram showing the arrangement of slave units in an embodiment of the method of communication of the invention.

### EMBODIMENT 1

A communication system which is preferably used in the method of communication of the invention will be generally described with reference to FIG. 1. As shown in FIG. 1, for example, a communication system used in the present invention comprises a plurality of (only two shown in FIG. 1) first instruments (slave units) 10 connected to a secondary power line L which supplies a commercial power source led to a building, a general home or factory or the like, and a master unit 20 which is connected to these slave units 10 through the secondary power line L for monitoring and controlling the slave units 10. In this manner, the system is fed with a commercial AC power through the secondary power line L of a distribution board. While the master unit 20 is shown in FIG. 1 as disposed downstream of the distribution board 30, it may be connected to the secondary power line which is located upstream of the distribution board 30 (service conductors from the pole) (not shown).

In the communication system shown in FIG. 1, a plurality of slave units 10 are installed in each building, factory, or general home while the master unit 20 is installed which is located most upstream of the slave units 10. The distribution board 30 is connected to a pole (not shown) through service connectors to be fed with 100V commercial power. The commercial power has a frequency which is 50 cycles per second in Kanto and is equal to 60 cycles per second in Kansai. The master unit 20 communicates with the plurality of slave units 10 using the method of communication according to the invention, and is also capable of communicating with a control center (not shown) through a suitable communication channel.

As shown in FIG. 1, the slave unit 10 comprises a contact input section 11, a memory 12, a load signal receiver 13, a calculation processor 14, a load signal generator 15; and a power supply 16, and is connected through a clamp to the secondary power line L which is branched from the distribution board 30 and extends to each convenience outlet. The contact input section 11 is clamped to the secondary power line L through a wiring, and detects the load quantity of a plurality of home appliances (not shown), for example, which are connected to each convenience outlet in terms of a current value, for example, converts an analog signal into a digital signal, and transmits it to the calculation processor 14. The address numbers and electrical load quantities of these home appliances are previously registered in the memory 12, and the calculation processor 14 compares the signal from the contact input section 11 against the address number in the memory 12, allowing the home appliance to be identified.

The load signal receiver 13 is clamped to the secondary power line L through a wiring, receives the load quantity of home appliances as detected by the contact input section 11 (accumulated current value), converts an analog signal into a digital signal and transmits it to the calculation processor 14. The calculation processor 14 calculates the load quantity on the basis of the signal from the load signal receiver 13, and transmits an address signal which is identified by a comparison of the signal indicating a result of calculation and the memory 12 to the load signal generator 15. On the basis of the address signal and the calculation signal indicating the load quantity from the calculation processor 14, the load signal transmitter 15 generates a load signal which depends on the address signal and the load quantity, and applies the load signal to the secondary power line L in timed relationship with the power frequency. For example, assuming that an alternating current defined as having a running average of 1.0 A over a given passed interval (hereafter referred to as “reference current”) flows through the secondary power line L and the AC waveform having this reference running average (hereafter referred to as “reference waveform”) exhibits a sinusoidal waveform as shown in FIG. 2 (a), a current value of 0.1 A which depends on the load quantity is augmented for an interval of one wavelength only of the reference waveform in response to the load signal from the slave unit 10 which is timed with respect to the power frequency, and the alternating current including the processed waveform in which the amplitude of the reference waveform is partially increased for an interval of only one wavelength as shown in FIG. 2 (b) flows, and an information signal represented by the processed waveform is transmitted to the master unit 20. At this time, the address signal is similarly formed as a processed waveform (to be described later) and transmitted to the master unit 20.

As mentioned above, the slave unit 10 detects the electrical load quantity of a home appliance or the like, applies a load signal which corresponds to the detected value to the secondary power line L in timed relationship with the power frequency, thus partially (which is for one wavelength in this example) processing the reference waveform flowing through the secondary power line L to form a processed waveform, and transmits the processed waveform as an information signal representing the load quantity of a home appliance or the like to the master unit 20. Accordingly, what occurs in accordance with the invention is only that the reference waveform is partially processed, and the alternating current including the processed waveform which represents the load quantity flows through the secondary power line L, and there is no superposition of a high frequency signal on the secondary power line L in addition to the reference current. In this manner, the problem of a radio wave leak attributable to the high frequency signal as experienced in the prior art does not occur on the secondary power line L, and thus the system is not subject to legal regulations under radio wave law, allowing an information signal representing the load quantity such as the load signal to be transmitted as the processed waveform.

On the other hand, the master unit 20 comprises a load signal receiver 21, a calculation processor 22, a portable radio set 23, a response processor 24, a shared memory 25, a command signal delivery section 26 and a power supply 27, as illustrated in FIG. 1, for example. The load signal receiver 21 receives the alternating current including the processed waveform as load signals from the plurality of slave units 20 through the secondary power line L1, convert these from an analog signal into a digital signal in configuration, and transmit them to the calculation processor 22. On the basis of the load signals from the load signal receiver 21, the calculation processor 22 recognizes the address numbers of the slave units 10 and the load quantities of the slave units 10 and store them in the shared memory 25. The portable radio set 23 informs the content (address numbers and load data relating to slave units 10) in the shared memory 25 to a control center (not shown) through a suitable communication channel while the response processor 24 processes the content of response by the communication between the portable radio set 23 and the control center, and stores a result of processings in the shared memory 25. The command signal delivery section 26 delivers a command signal to a marking circuit (for example, a switching circuit) on the secondary power line L side, thus applying timing marks to the reference waveform on the secondary power line L by means of the marking circuit to form processed waveforms with timing marks.

FIG. 3 shows a processed waveform which is formed by using a switching circuit 40 as the marking circuit. Specifically, the command signal delivery section 26 delivers a command signal to the switching circuit 40 which is connected thereto, and transmits command signals to the plurality of slave units 10 through the switching circuit 40. The switching circuit 40 performs an ON, OFF control of the power source every one-half wavelength of the reference waveform on the basis of the command signals and in timed relationship with the power frequency, thus processing the reference current into cut waveform by momentarily interrupting it as shown in FIG. 3. Since the interruption takes place in a very short interval, the interruption cannot be visually recognized. In this instance, the reference waveform is interrupted by momentarily cutting the power source at the zero crossover shown in FIG. 3 (a) by cooperating with a zero crossover detection circuit (not shown). By way of example, a section of the reference waveform which corresponds to the interrupted one-half wavelength may be defined as a signal “1” while a one-half wavelength section which is not interrupted may be defined as a signal “0”, and it is possible to provide a variety of command signals each comprising an array of the plurality of processed waveforms to define a variety of command signals denoted in the binary code to be transmitted to the plurality of slave units 10.

For example, the switching circuit 40 may be operated by a command signal from the master unit 20 to transmit a command signal “11001”, which comprises an array of signals “1”, “1”, “0”, “0” and “1” as shown is FIG. 3 (b) as an operation command signal to the slave unit 10. When receiving the operation command signal through the load signal receivers 13, the plurality of slave units 10 recognizes the command signal “11001” as an operation command signal to operate in a salvo fashion, each transmitting its address number and load data to the master unit 20 in a salvo fashion for purpose of communication. It is to be noted that each slave unit 10 does not operate if it receives signals other than disposed in the above array.

The reception and the transmission of a series of information signals mentioned above between the slave units 10 and the master unit 20 enables the master unit 20 to transmit a command signal to the plurality of slave units 20 in a salvo fashion through the secondary power line L1, and also enables the plurality of slave units 20 to operate on the basis of the command signal from the master unit 20 to transmit load data carried by the plurality of slave units 10 to the master unit 20 in a salvo fashion for purpose of communication. In addition, the master unit 20 can control data from the plurality of slave units 10 collectively in the shared memory 25, and can transmit load data which depends on the content of a command from the control center to the control center.

### EMBODIMENT 2

FIG. 4 shows an alternating current waveform including processed waveforms which is transmitted from the slave unit 10 to the master unit 20 in this embodiment. Specifically, an arrangement is such that as shown in FIG. 4, a current value which is by a given permissible load quantity (for example, current value) ΔI higher than a peak value A of the reference waveform is previously set up as a permissible value B, and this value is stored in the shared memory 25 of the master unit 20. When the slave unit 10 applies a load signal to the secondary power line, the master unit 20 determines a normal load quantity when the peak value C of the processed waveform, which is formed by partially processing the reference waveform on the basis of the load signal is located between the peak value A and the permissible value B as shown in this Figure, and determines an abnormal load quantity for a peak value D which exceeds the permissible value B. In this manner, the master unit 20 can determine whether the load quantity is normal or not on the basis of the processed waveform which is formed on the basis of the load signal from the slave units 10.

### EMBODIMENT 3

FIG. 5 shows an alternating current waveform including processed waveforms which is transmitted from the slave unit 10 to the master unit 20 in this embodiment. In this embodiment, the magnitude of the load quantity is set up over a plurality of stages as shown, and inherent information is imparted which depends on the level of the load quantity. A load signal which corresponds to each of these load quantities is applied to the secondary power line in timed relationship with the power frequency. The amplitude of the reference waveform increases locally in response to the load signal, and the increased portion (processed waveform) is classified into a plurality of stages (or three stages in this embodiment) in accordance with the magnitude of the increase. Inherent information is imparted to each level of the increase. Specifically, the peak value of the reference waveform as shown in FIG. 5 is defined as a signal “0”. A first level L1 which is one stage higher than the peak is defined as a signal “1” and further higher first and second level L2, L3 are defined as signals “2”, “3”. Inherent information is imparted to processed waveforms which correspond to the first, the second, and the third level L1, L2, L3, respectively. In this manner, an information signal can be defined in a quaternary code depending on the level of the processed waveform, allowing four different information to be imparted depending on the level of the processed waveform for an interval corresponding to one-half wavelength. Accordingly, for an interval corresponding to two wavelengths, 42 different information (for example address information or the like) can be imparted. For example, FIG. 5 shows an address information of “3211” denoted in the quaternary code. It is to be noted that information for an address number or the like can also be represented by the processed waveform for an interval corresponding to only one-half wavelength.

### EMBODIMENT 4

FIG. 6 shows an alternating current waveform including processed waveforms which is transmitted from the slave unit 10 to the master unit 20 in this embodiment. In this embodiment, a plurality of processed waveforms are formed within a unit time, and inherent information is imparted depending on the number of processed waveforms. Specifically, as shown in FIG. 6, a peak value B which is by a given current value AI augmented to the peak value A of the reference waveform is set up as a permissible value for the processed waveform. A signal “0” is defined for the reference waveform. A signal “1” is defined for the processed waveform having a peak value which is located between the peak value of the reference waveform and the permissible value. Inherent information is imparted by a binary denotation formed by an array of “0” and “1”. In the instance shown in FIG. 6, “10110” in binary denotation is shown, and inherent information may represent the address number of the slave unit 10, for example. In FIG. 6, the load signal is applied every one-half wavelength, but the load signal may be applied every wavelength as shown in FIG. 7. In this instance, the address information or the like may also be formed over a plurality of wavelength regions at the same time as the load quantity is formed to be applied to the secondary power line, as shown in FIG. 2 (b). Specifically, the processed waveforms representing the load quantity may be contained within the reference waveform in the form of an array representing an address number in a unit time, thus allowing the load quantity and the address information to be simultaneously transmitted to the master unit 20.

### EMBODIMENT 5

FIGS. 8(a)˜(c) show alternating current waveforms including processed waveforms which are transmitted from the master unit 20 to the slave units 10 in this embodiment. In this embodiment, processed waveforms which are similar to the processed waveforms shown in FIG. 3 are illustrated. The processed waveforms of FIG. 8 (a) are of the same kind as the processed waveforms shown in FIG. 3 (b). Processed waveforms shown in (b) of this Figure are formed by increasing or decreasing the current interruption interval by the switching circuit 40 (see FIG. 1) in response to a command signal from the master unit 20. As referenced to the zero crossover in the one-half wavelength, the interruption of the power source for a time interval of “1” defines a signal “1”, and the interruption of the power source for an interval which is five times as long defines a signal “5”. By imparting an inherent command content to these information signals, it is possible to transmit a variety of command signals from the master unit 20 to the slave units 10. For example, for the signal “1”, the slave unit 10 having the address number “1” is operated while for the signal “5”, the slave unit having the address number “5” can be operated. In this manner, the slave units 10 can be individually controlled. A variety of information can also be imparted by intermittently interrupting the power source for an equal time interval as referenced to the zero crossover within one-half wavelength. Each interruption defines an information signal “1”. In this manner, a variety of information can be imparted in binary denotation by processed waveforms which are formed within one-half wavelength and within a unit time. FIG. 8 (c) represents inherent information of “1000100” in binary denotation (which may be an address information of the slave unit 10, for example).

### EMBODIMENT 6

FIGS. 9(a)˜(c) are illustrations of configurations of operation of the slave units 10 in this embodiment. In this embodiment, a plurality of (which are only three in this embodiment) slave units 10 each has a delay circuit (not shown). When the power is turned on by the breaker 31 in the distribution board 30, an alternating current on the secondary power line L causes a plurality of slave units 10 to operate simultaneously. The delay circuit of each slave unit 10 is set up with a mutually different time interval. By way of example, FIG. 9 (b) shows a sequence in which the slave units 10A, 10B, 10C operate with a time difference therebetween for a given time interval which represents a one course. When the slave units 10A, 10B, 10C operate with a time difference therebetween, an interference of signals transmitted to the master unit 20 can be avoided, allowing load information from the slave units 10A, 10B, 10C to be transmitted exactly. A transmission information in this instance may utilize the load signal in the described embodiments.

By way of example, FIG. 9 (b) shows a timing chart having a one course of “10” where the slave units 10A operates at “1”, and then the slave units 10B, 10C sequentially operate at “2”, “3” of the timing chart. The slave units 10A, 10B, 10C again operate with a time difference therebetween when “1”, “2” and “3” appears again in the timing chart. FIG. 9 (c) illustrates that for one course of 10 seconds, the slave units 10A, 10B and 10C operate with a time difference of one second therebetween.

### EMBODIMENT 7

FIGS. 10(a), (b) are illustrations of configurations of operation of the slave units 10 in a similar manner as in the embodiment 6. This embodiment is similar to the embodiment 6 in that the plurality of slave units 10 operate with a time difference therebetween through respective delay circuits (not shown). However, in this embodiment, rather than operating the slave units 10A, 10B, 10C in response to the turn-on of the power by the breaker 31, the slave units 10A, 10B, 10C operate on the basis of signals sensed by associated sensors 41, 42, 43. A similar functioning and effect can be expected in this embodiment as in the embodiment 6.

### EMBODIMENT 8

FIGS. 11 (a)˜(c) are illustrations of configurations of operation of the slave units 10 in a similar manner as in the embodiment 7. This embodiment is similar to the embodiment 6 in that the plurality of slave units 10 operate with a time difference therebetween through respective delay circuits (not shown). However, in this embodiment, a noise generator 50 is installed on the secondary power line. L at a location which is most upstream of the slave units 10A, 10B, 10C and downstream of the breaker 31. The noise generator 50 operates upon receiving a command signal from the master unit 20, and the slave units 10A, 10B, 10C operate on the basis of a noise signal from the noise generator 50. In this embodiment, a similar functioning and effect as in the embodiment 7 can be expected. It is to be noted that the noise generator 50 may be installed upstream of the breaker 31.

It is to be understood that the method of communication according to the invention is in no way limited to the described embodiments, and that any method in which an alternating current waveform on a power line is processed to provide a processed waveform and the processed waveform is contained in the alternating current as inherent information signal in the transmission is envisaged as lying within the present invention.

### INDUSTRIAL AVAILABILITY

The present invention can be preferably utilized in constructing a communication network which utilizes a power line.

### BRIEF DESCRIPTION OF THE DRAWINGS

FIG. 1: a block diagram showing an exemplary communication system used in the method of communication of the present invention.

FIG. 2 (a), (b): illustrating the principle of the method of communication of the present invention where (a) is a waveform diagram showing an alternating current waveform of a commercial power source and (b) is a waveform diagram showing a processed waveform when a load signal is applied to the alternating current shown in (a).

FIG. 3 (a), (b): illustrating the principle of the method of communication of the invention where (a) is a waveform diagram showing a waveform cut at the zero crossover of the alternating current waveform of a commercial power source and (b) is a waveform diagram of a processed waveform including a plurality of cut waveforms.

FIG. 4: a waveform diagram showing processed waveforms according to another embodiment of the method of communication of the invention.

FIG. 5: a waveform diagram showing processed waveforms according to a further embodiment of the method of communication of the invention.

FIG. 6: a waveform diagram showing processed waveforms according to still another embodiment of the method of communication of the invention.

FIG. 7: a waveform diagram showing processed waveforms according to a still further embodiment of the method of communication of the invention.

FIG. 8: a waveform diagram showing processed waveforms according to yet another embodiment of the method of communication of the invention.

FIG. 9: an illustration of slave units of a communication system used in an embodiment of the method of communication of the invention where (a) is a block diagram showing the arrangement of the slave units, (b) a timing chart for the operation of the slave units, (c) a time axis illustrating the time of operation of the slave units.

FIG. 10: an illustration of slave units of a communication system used in an embodiment of the method of communication of the invention where (a) is a block diagram showing the arrangement of a plurality of slave units, and (b) a timing chart for the operation of the slave units.

FIG. 11: a block diagram showing the arrangement of a plurality of slave units in an embodiment of the method of communication of the invention.

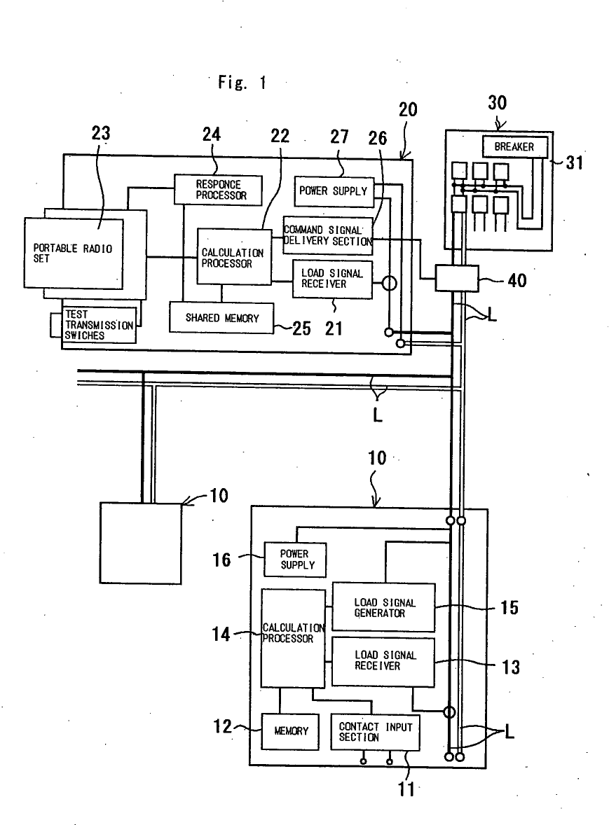

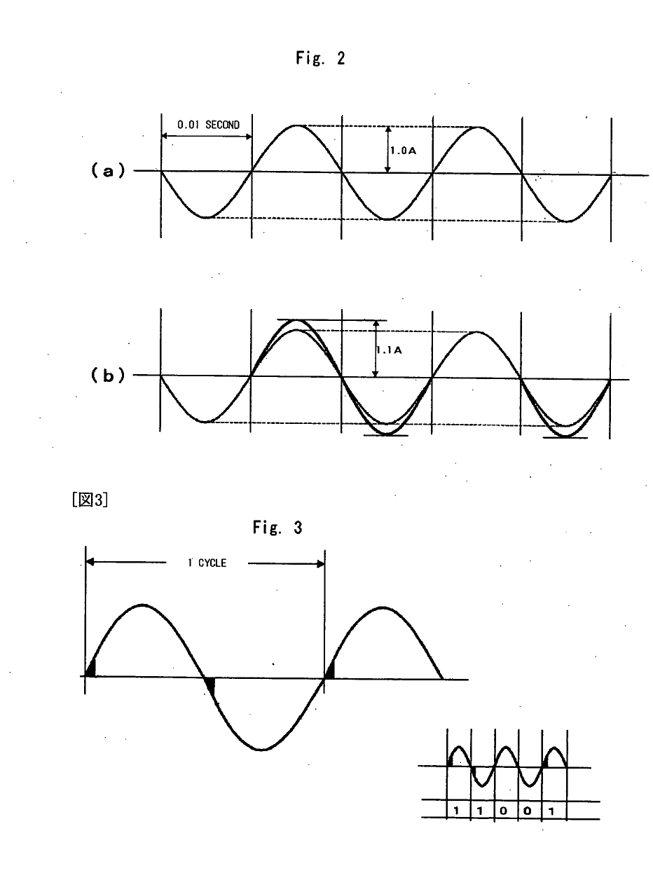

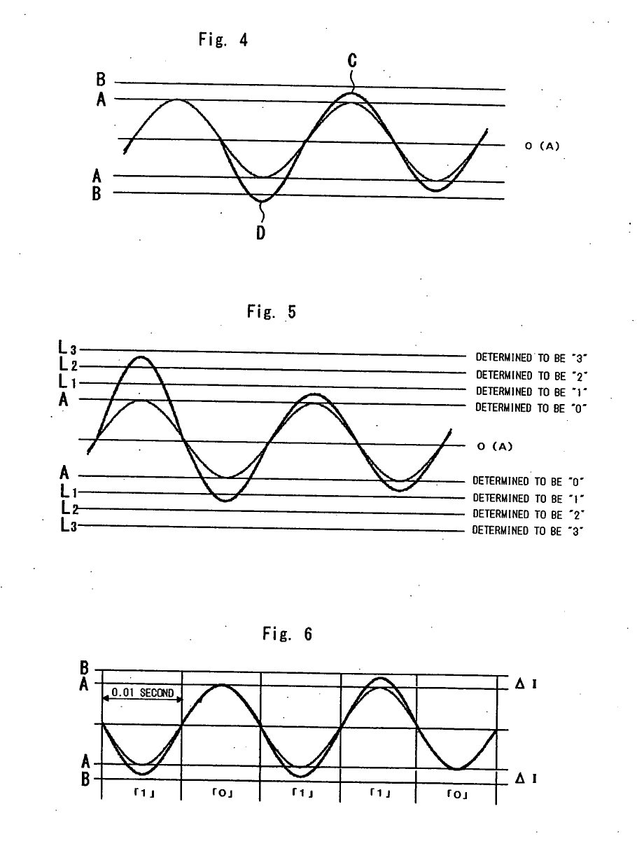

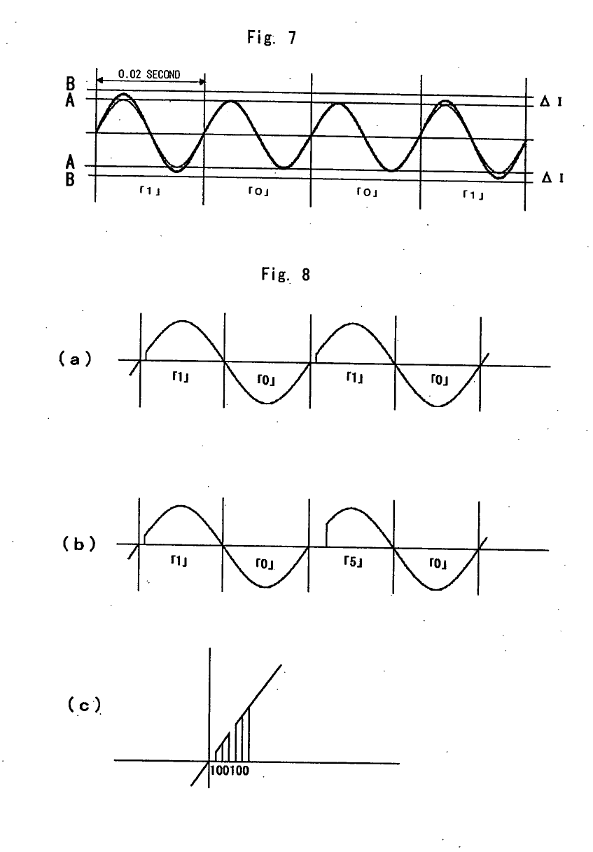

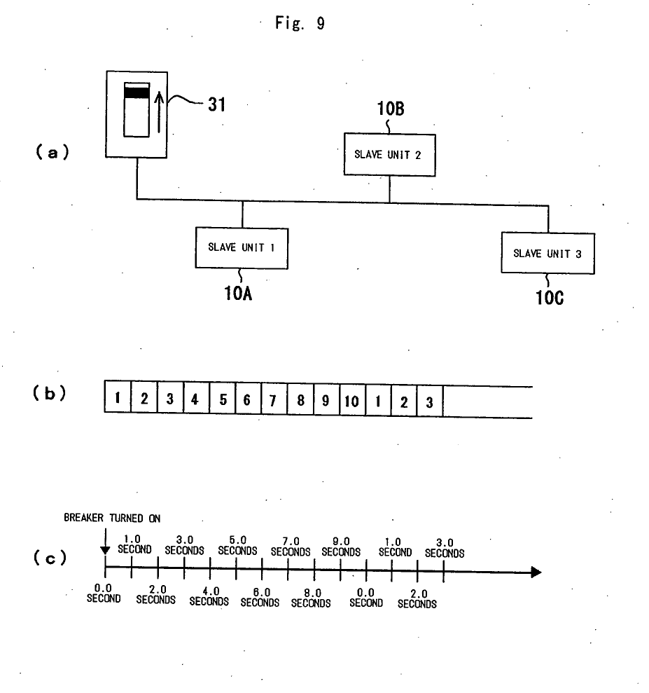

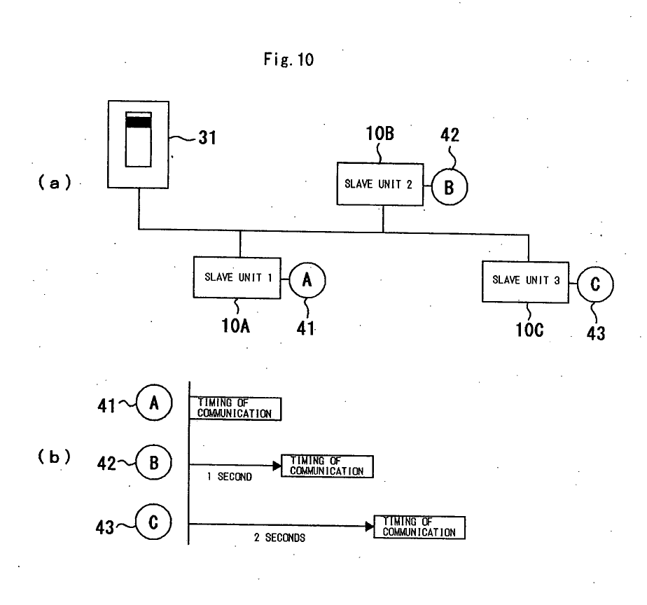

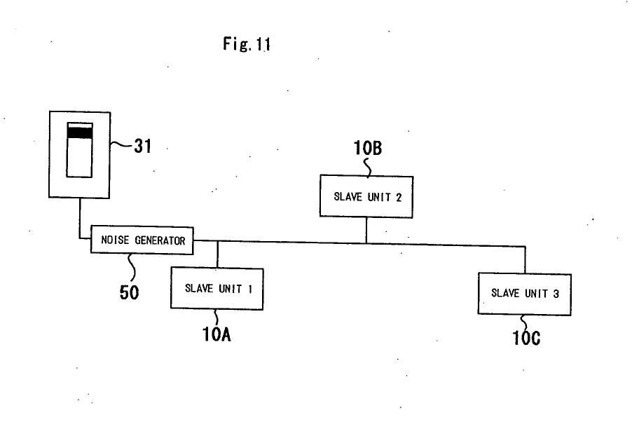

### DESCRIPTION OF CHARACTERS

10 slave unit (first instrument)
13 load signal receiver
15 load signal generator
20 master unit (second instrument)
21 load signal receiver
26 command signal delivery section
40 switching circuit
L power line

1-13. (canceled)

14. In a method of communication using an alternating current on a power line, a method of communication utilizing a power line characterized by applying a load to the power line to partially process the waveform of the alternating current on the power line on the basis of the load, and transmitting the alternating current including the processed waveform as an information signal representing the load.

15. A method of communication utilizing a power line according to claim 14, wherein the load is applied from at least one first instrument to which the load is connected.

16. A method of communication utilizing a power line according to claim 15, wherein the first instrument is connected to a second instrument which monitors the first instrument, that a given range is set on the load quantity of the load, and that the second instrument determines whether or not the load quantity is proper on the basis of the range.

17. A method of communication utilizing a power line according to claim 15, comprising setting the magnitude of the load quantity over a plurality of stages in the first instrument, which applies to the power line inherent information in accordance with the level of each load quantity.

18. A method of communication utilizing a power line according to claim 15, wherein a marking circuit which operates on the basis of a signal from the second instrument partially marks the waveform of the alternating current on the power line to provide a second processed waveform, and transmits the alternating current including the second processed waveform to the first instrument as an information signal.

19. A method of communication utilizing a power line according to claim 18, wherein the marking comprises momentarily interrupting the alternating current waveform at least once.

20. A method of communication utilizing a power line according to claim 19, wherein a plurality of first instruments transmit load signals to the second instrument on the basis of a signal from the second instrument.

21. A method of communication utilizing a power line according to claim 16, wherein a plurality of first instruments are connected to the second instrument, are simultaneously energized as the power is turned on, and operate sequentially with a given time difference from each other on the basis of preset times in the plurality of first instruments.

22. A method of communication utilizing a power line according to claim 21, wherein as the plurality of first instruments operate, the plurality of first instruments transmit signals to the second instrument.
